(19) United States
(12) Patent Application Publication
(10) Pub. No.: US 2014/0232115 A1
(43) Pub. Date: Aug. 21, 2014

(54) Funnel Jet Electric Generator

(71) Applicants: Kam Chu LO, West Covina, CA (US); Raymond LO, West Covina, CA (US)

(72) Inventors: Kam Chu LO, West Covina, CA (US); Raymond LO, West Covina, CA (US)

(21) Appl. No.: 13/768,913

(22) Filed: Feb. 15, 2013

(51) Int. Cl. F03B 13/22

(52) U.S. Cl. CPC F03B 13/22
USPC 290/53

(57) ABSTRACT

A funnel jet electric generator includes at least one funnel jet each having a funnel body defining a channel, a funnel extension tube connected to a first end portion of the funnel body for capturing a wave crest, and a nozzle connected to a second end portion of the funnel body, wherein the wave crest is guided into the funnel body along the channel and projects out through the nozzle to produce a water jet. The kinetic energy of the water jet is transmitted to the electric generator for producing electricity through the power transmission system.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to an electric generator, and more particularly to an electric generator adapted for using the renewable energy of wave power, which utilizes the kinetic energy of moving sea waves which propagate from the sea towards a beach, gulf, or cliff bank.

2. Description of Related Arts

Wave power, which is the energy of surface waves in fluids such as a river, a sea, or an ocean, is a type of clean and renewable energy. Many efforts have been taken to convert this wave power to more useful forms of energy. A conventional wave energy converting system comprises a floating structure with a power transmission system which displays a rotary motion in response to the wave action so as to transform the wave energy into mechanical energy that can be stored and transferred for further utilization.

However, the floating structure that floats freely on the water's surface may fail to provide the continuous rotation required for the transformation to mechanical energy because its tilt movement with respect to the water's surface, under the impact of the waves, generally moves it from its equilibrium position. In addition, smaller waves will not be effective in providing sufficient torque to drive the power transmission system of the floating structure. Therefore, a wave energy converting device which is capable of retaining its relative position with respect to the water's surface in the waves and producing stable continual energy transformation is required.

### SUMMARY OF THE PRESENT INVENTION

The present invention is advantageous in that it provides a funnel jet electric generator adapted for using the renewable energy of wave power, which utilizes the kinetic energy of moving sea waves which propagate from the sea toward a beach, gulf, or cliff bank.

Another advantage of the present invention is to provide a funnel jet electric generator comprising at least one funnel jet, at least one power transmission system, and at least one electric generator, wherein each of the funnel jet is adapted for producing water jets that operates on the power transmission system for driving the electric generator.

Another advantage of the present invention is to provide a funnel jet electric generator, wherein when a wave crest passes the funnel jet, a water jet is produced for driving the electric generator, wherein when a wave trough passes the funnel jet, no water jet is produced, however the water jet produced by the wave crest is strong enough to keep the power transmission system running before the next wave crest comes, so that the electric generator generates electricity continuously.

Another advantage of the present invention is to provide a funnel jet electric generator, wherein the funnel jet has a first larger open end for capturing wave crests and a second smaller open end for releasing the captured wave crests, thus a stable, strong, and high speed water jet is produced when a wave crest passes the funnel jet. Therefore, a relatively small wave crest is still able to produce an enough torque to drive the power transmission system when passing through the funnel jet.

Another advantage of the present invention is to provide a funnel jet electric generator, wherein the funnel jet comprises a nozzle for projecting the water jet, wherein the nozzle is tilted up clear out of the water level, and thus resistance of water is avoided.

Another advantage of the present invention is to provide a funnel jet electric generator, wherein a tilt up angle which is defined by a middle line of the funnel jet and the water level maintains substantially the same, and thus the pattern of the water jets is maintained for providing a substantially regular torque to drive the power transmission system.

Another advantage of the present invention is to provide a funnel jet electric generator, wherein the funnel jet lies on at least one buoy floating on the water, and thus the funnel jet electric generator is capable of being mounted in a sea or in a river.

Another advantage of the present invention is to provide a funnel jet electric generator, wherein the funnel jet is secured by posts or chains mounted on the ground in a sea or river, wherein the posts or chains allow the funnel jet to move up and down in response to the wave tide, and thus the funnel jet maintains at the water level and produces continual water jets.

Another advantage of the present invention is to provide a funnel jet electric generator, wherein the funnel jet can be effectively used in sea waves or even in the water flow of a river and stream to turn any type of turbines or propellers of the power transmission system for driving the electric generator.

Another advantage of the present invention is to provide a funnel jet electric generator, wherein no complicated structure is employed for producing electricity and the funnel jet electric generator can be placed at any location which has water waves or water flows.

Additional advantages and features of the invention will become apparent from the description which follows, and may be realized by means of the instrumentalities and combinations particular point out in the appended claims.

According to the present invention, the foregoing and other objects and advantages are attained by funnel jet electric generator comprising at least one funnel jet each of which comprises a funnel body defining a channel, a funnel extension tube connected to a first end portion of the funnel body for capturing a wave crest, a nozzle connected to a second end portion of the funnel body, a power transmission system, and an electric generator, wherein the wave crest is guided into the funnel body along the channel and projects out through the nozzle to produce a water jet, wherein kinetic energy of the water jet is transmitted to the electric generator for producing electricity through the power transmission system.

In accordance with another aspect of the invention, the present invention provides a method for manufacturing a funnel jet electric generator to use wave power to generate electricity, comprising the following steps.

(a) Define a relatively large entrance at a first side of a funnel jet for capturing a wave crest and a relatively small exit at a second side thereof.

(b) Compress the wave crest via a channel in the funnel body of the funnel jet in such a manner that the wave crest is projected out through the relatively small exit to create a water jet; and

(c) Transmit the kinetic energy of the water jet to drive an electric generator to produce electricity.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of a funnel jet according to a preferred embodiment of the present invention.

FIG. 2 is a top view of the funnel jet according the above preferred embodiment of the present invention.

FIG. 3 is a front view of the funnel jet according the above preferred embodiment of the present invention.

FIG. 4 is a sectional view of a funnel jet electric generator according to a preferred embodiment of the present invention.

FIG. 5 is a front view of the funnel jet electric generator according to the above preferred embodiment of the present invention.

FIG. 6 is a rear view of the funnel jet electric generator according to the above preferred embodiment of the present invention.

FIG. 7 is a top view of the funnel jet electric generator according to the above preferred embodiment of the present invention.

FIG. 8 is an enlarged partial view of a gearbox and an open/close water nozzle plate system of the funnel jet electric generator according to the above preferred embodiment of the present invention.

FIG. 9 illustrates the funnel jet electric generator being installed at a preferred location, such as a gulf area or a beach area, according to the above preferred embodiment of the present invention.

FIG. 10 illustrates the installation of the funnel jet electric generator in big and short wave crest areas according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

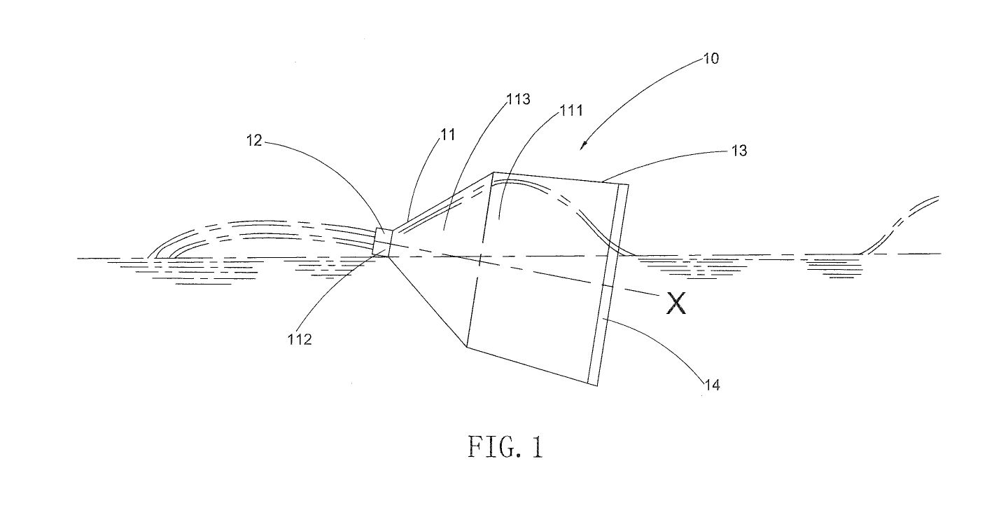

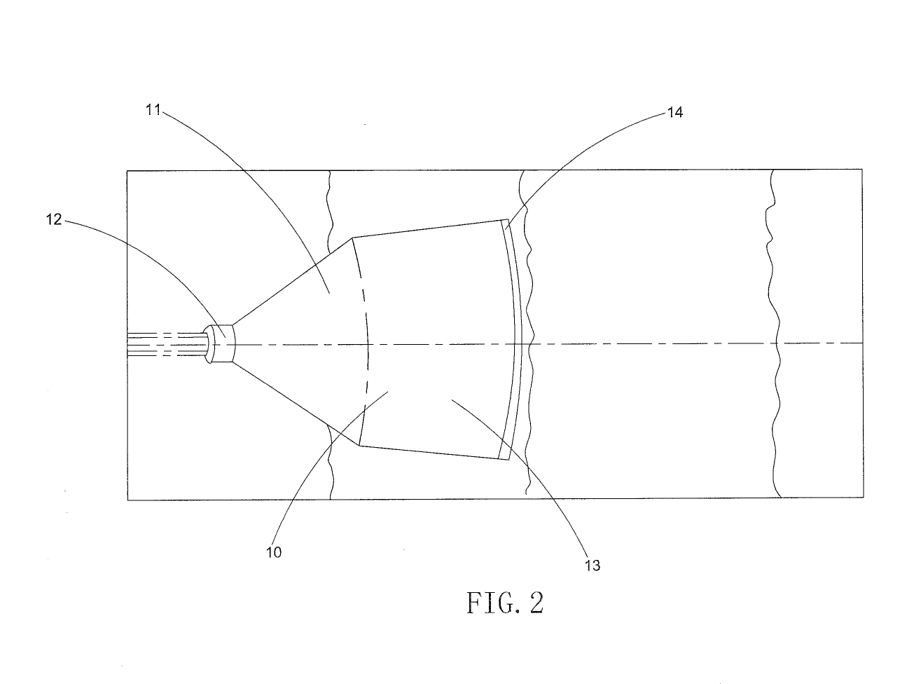

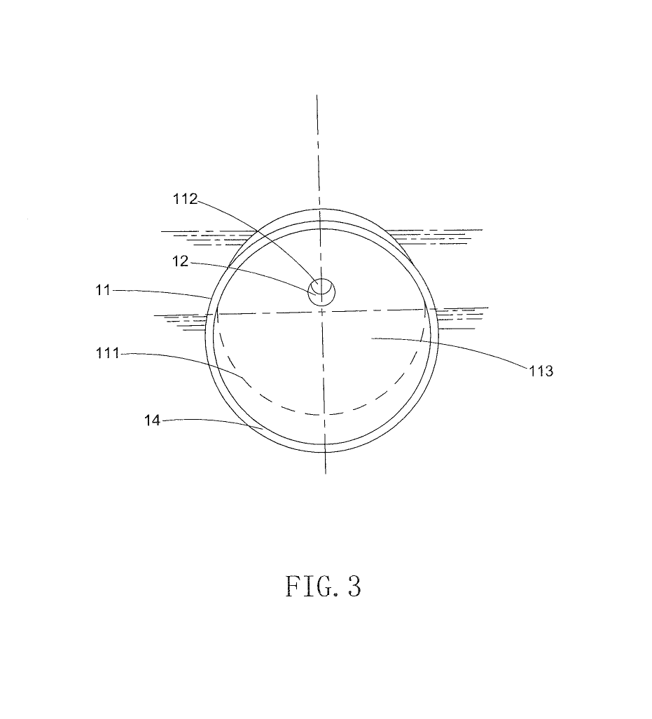

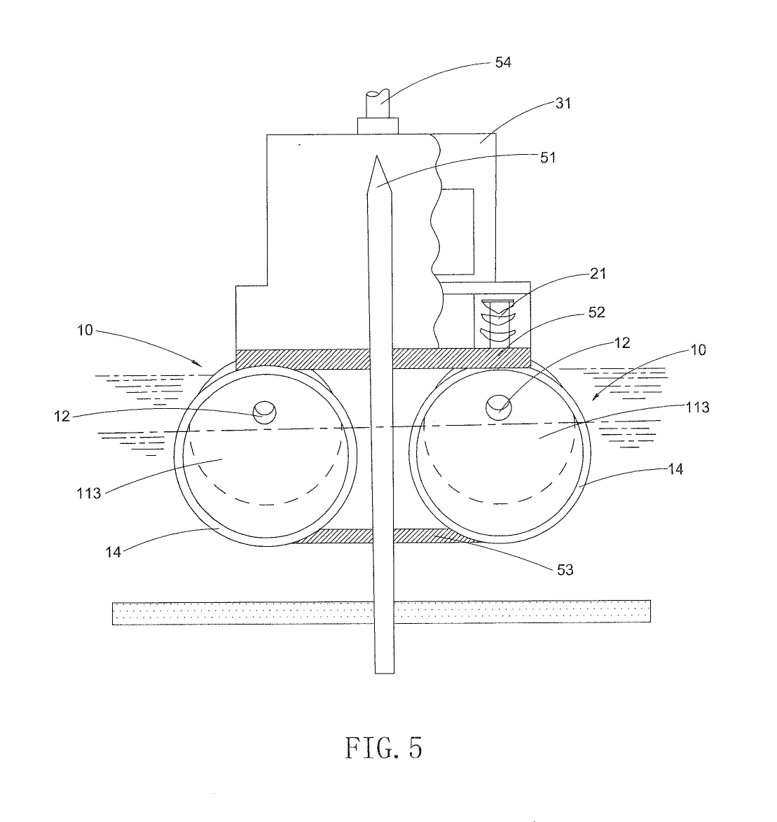

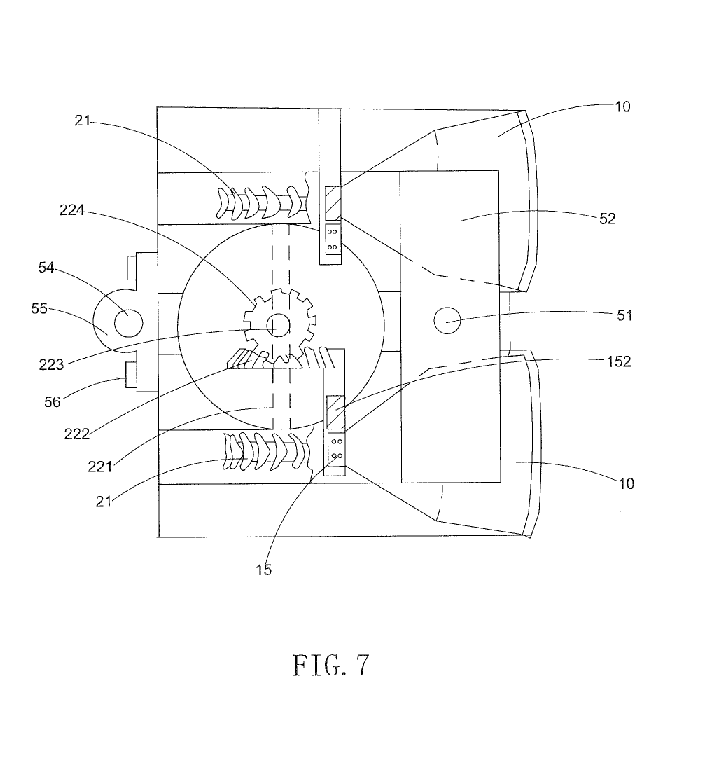

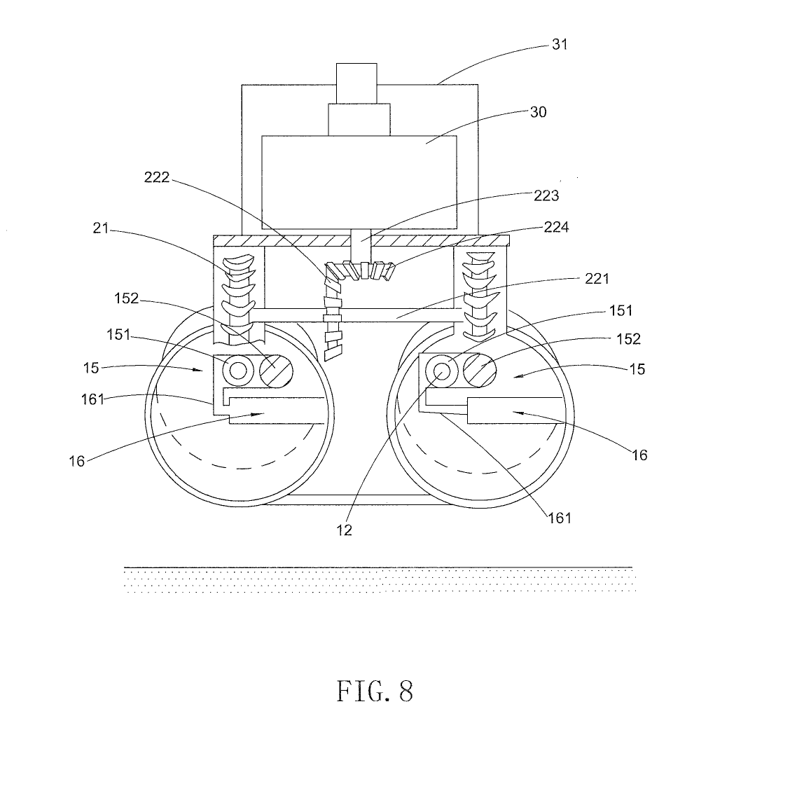

Referring to FIGS. 1 to 10 of the drawings, a funnel jet electric generator according to a preferred embodiment of the present invention is illustrated. The funnel jet electric generator comprises at least one funnel jet 10, at least one power transmission system 20, and at least one electric generator 30. The funnel jet 10 is arranged for capturing a series of wave crest in a sea or river for producing water jets that operate the power transmission system 20 which drives the electric generator 30 to produce electricity.

Accordingly, wave power is transmitted to the power transmission system 20 via the water jets and transformed into mechanical energy in the power transmission system 20, and then the mechanical energy is transformed into electric power via the electric generator 30 and is stored for further utilization.

More specifically, referring to FIGS. 1 to 3 of the drawings, the funnel jet 10 of the funnel jet electric generator is illustrated. The funnel jet 10 comprises a funnel body 11 which defines an inlet 111, an outlet 112, and a channel 113 for communicating with the inlet 111 and the outlet 112. The funnel body 11 can be constructed in any shape such as round shape. In this preferred embodiment, the funnel body 11 has a gradually reducing diameter from the inlet 111 to the outlet 112.

When a wave crest comes to pass through the funnel body 11, the wave crest enters into the channel 113 of the funnel body 11 through the inlet 111 and exits of the funnel body 11 through the outlet 112 for creating the water jet.

As shown in the drawings, the funnel jet 10 comprises a nozzle 12 at one end of the funnel body 11 at the outlet 112 thereof, and a funnel extension tube 13 extended from the other end of the funnel body 11 at the inlet 111 thereof. It is worth mentioning that the funnel extension tube 13 can be integrated with the funnel body 11 to form a one-piece structure. In other words, a part of the funnel body 11 can form the funnel extension tube 13.

Accordingly, the nozzle 12, which is relatively smaller in size, is arranged for projecting the water jet; and the funnel extension tube 13, which is relatively larger in size, is used for capturing the waves. Therefore, when the wave crest enters the large entrance of the funnel extension tube 13 and moves forward into the funnel body 11, the wave crest is compressed and guided out of the small nozzle 12 and a high speed water jet is forced out of water's surface into the air. When the whole wave crest has passed, the water jet stops, and a water trough passes through the funnel jet 10 and waits for the next wave crest to come to create another water jet.

In other words, the funnel extension tube 13 is used for collecting the wave crests, and guides the wave crests into the channel 113 of the funnel body 11. Due to the gradually reducing diameter, the energy of the wave crest is collected and transmitted along an inner surface of the funnel body 11 in the channel 113. When the wave crest reaches the nozzle 13 at the outlet 112, the energy of the wave crest is suddenly released and a high speed water jet is created.

Accordingly, the energy of the wave crest is transformed into the kinetic energy of the water jet via the funnel jet 10, and thus the kinetic energy of the water jet is strong enough to operate on the power transmission system 20 which drives the electric generator 30.

It is worth mentioning that the funnel jet 10 is semi-submerged and lays on the water in the sea or river according to this preferred embodiment. More specifically, the nozzle 12 of the funnel jet 10 is arranged to tilt up clear out of the water level to avoid the resistance of water. Accordingly, a tilt up angle is defined between a central axial line of the funnel jet 10 and the water surface line.

In other words, the center of gravity of the funnel jet 10 is adjacent to the side of the funnel extension tube 13, and thus the funnel jet 10 is inclinedly provided on the water with the nozzle 12 being provided above the water surface. Therefore, the water jet is ensured to be projected into the air when the wave crest passes through the funnel jet 10.

As shown in the drawings, the funnel jet 10 further comprises a reinforce ring 14 mounting the funnel extension tube 13 in position, and thus the funnel body 11 and the funnel extension tube 13 are extended between the nozzle 12 and the reinforced ring 14.

The mechanism of the funnel jet 10 can be further illustrated in this following experiment. Using one hand, hold a funnel jet model on the water in a bath tub, and with the other hand hit the water to create waves. When the wave crests pass through the funnel jet model a high speed water jet will come out of water surface.

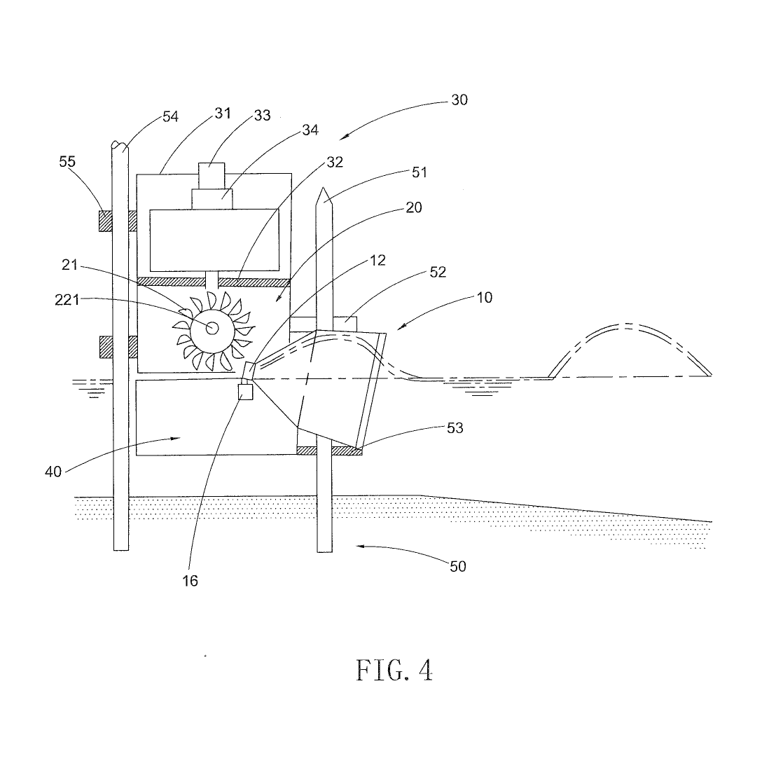

Referring to FIGS. 4 to 8 of the drawings, the funnel jet electric generator incorporated with the funnel jet in FIGS. 1 to 3 of the drawings is illustrated in details. According to this preferred embodiment, the funnel jet electric generator comprises two funnel jets 10 for driving the power transmission system 20.

The water jet created by each of the funnel jets 10 can be used both is sea waves and the water flow of river to turn any type of turbines or propellers to drive the electric generator 30 to produce electricity. In this preferred embodiment, the power transmission system 20 comprises two bucket turbines 21 each of which is propelled by the water jet respectively created by the funnel jet 10 and a transmission gear mechanism 22 that is driven by the two bucket turbines 21. Accordingly, the bucket turbines 21 are employed for driving the electric generator 30 through the transmission gear mechanism 22.

As shown in FIG. 4 of the drawings, electric generator 30 is illustrated in more detail. A housing 31 is used for receiving the electric generator 30 and an electric generator floor 32 is used for supporting the electric generator 30. Other structures such as a bearing 33 and a rotating slip ring 34 are also illustrated in the drawings and are exemplary only.

It is worth mentioning that the kinetic energies of the water jets respectively created by the two funnel jets 10 are transmitted to the electric generator 30 through the transmission gear mechanism 22, and thus the power required for driving the electric generator 30 is supplied. In other words, the two funnel jets are used for catching more wave energy for ensuring the normal working order of the electric generator 30 which is arranged to continuously generating electricity. Accordingly, three or more funnel jets 10 can also be used.

In addition, when two or more funnel jets 10 are used together, for example when two funnel jets 10 are arranged in a line to produce the water jets, the individual irregular transverse motions of the two funnel jets 10 when the wave crest passes through the funnel jets 10 are cancelled out, thus the whole structure is maintained in a balance.

Therefore, when the wave crest is propagated to the funnel jets 10 through the funnel extension tubes 13, the wave kinetic energy will press the water out through the small nozzles 12, and thus high speed water jets will exit to impulse the bucket turbines 21 that drive the electric generator 30 through the transmission gear mechanism 22. Conversely, when the wave trough is passes, no wave power is generated to propel the electric generator 30, but the inertia of the electric generator 10 and the two bucket turbines 21 allow the two bucket turbines to spin for a while. Therefore, the funnel jet electric generator of the present invention works like a simple single-coiled electric generator whose armature winding is a loop or single coil rotating in a magnetic field. When the coil rotates to the position cutting the magnetic line flux a voltage and current are induced, but when the coil rotates to the position of not cutting the magnetic line flux, then no voltage and current are induced.

As an example of the transmission gear mechanism 22, the transmission gear mechanism 22 comprises a connecting shaft 221 linking the two bucket turbines 21, a connecting shaft gear 222 which is coupled with the connecting shaft 221 of the two bucket turbines 21, a generator shaft 223 coupled with the electric generator 30, and a generator gear 224 coupled with the generator shaft 223 of the electric generator 30. Accordingly, the kinetic energy of the water jet is directed to the electric generator through the connecting shaft 221, the connecting shaft gear 222, the generator gear 224, and the generator shaft 223 of the transmission gear mechanism 22. This is a simple direct transmission system because it can be increase or decrease gears to increase or decrease the speed of the electric generator 30.

The power transmission system further comprises a gear box 23 for receiving the transmission gear mechanism 22. Accordingly, the two bucket turbines 21 are respectively installed at two sides of the gear box 23. The transmission gear mechanism 22 is installed in the gear box 23.

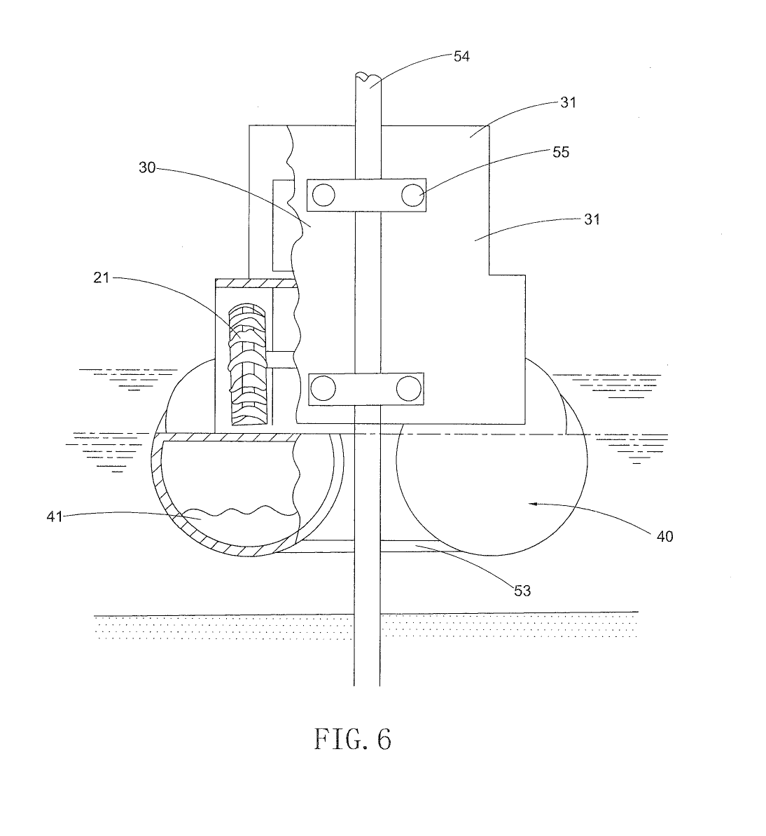

The funnel jet electric generator further comprises at least one buoy 40 arranged for supporting the whole apparatus. According to this preferred embodiment, the funnel jet electric generator comprises two buoys 40. The whole funnel jet generator is laid on the two buoys 40. The floating depth can be adjusted by adjusting the water ballast 41 in the two buoys 40, as shown in FIG. 6 of the drawings.

Accordingly, the two funnel jets 10 are respectively laid on the two buoys 40 in such a manner that each of the nozzles 12 is tilted out of the water surface to avoid the resistance of water. Each of the buoys 40 further comprises a water ballast 41. The volume of the water ballast 41 can be adjusted so as to adjust the floating depth of the two funnel jets 10.

It is worth mentioning that the opening and closing of the water jet of each of the funnel jets 10 can be controlled. More specifically, the funnel jet 10 of this preferred embodiment further comprises a connecting plate 15 comprising a nozzle ring 151 and a nozzle blocking member 152 which can be embodied as a round plate, wherein the connecting plate 15 is adapted for moving between an open state and a closed state. When in the open state, the nozzle ring 151 is moved to be positioned at the nozzle 12 of the funnel jet 10, so that the funnel jet 10 works and water jets are project out through the nozzle 12. When in the closed state, the nozzle blocking member 152 is moved to seal the nozzle 12 of the funnel jet 10, so that the water jets are blocked to stop the electric generator 30.

The funnel jet 10 further comprises an actuator 16, which can be a solenoid, an air cylinder, or a hydraulic cylinder installed at one of the two buoys 40. The connecting plate 15 is installed to an end of a rod 161 of the actuator 16 in such a manner that the connecting plate 15 is actuated to transversely move on the nozzle 12 of each of the funnel jets 10. Accordingly, when the rod 161 of the actuator 16 is driven to stretch back and forth to guide the connecting plate 15 to move between the open state and closed state. It is worth mentioning that the two funnel jets 10 are preferably opened together and closed together.

It is worth mentioning that each of the connecting plate 15 is connected to one of the two buoys 40 via the actuator 16, so that when the two buoys 40 float up and down with the tide, the nozzle 12 will move up and down to stay out of the water surface to avoid the resistance of the water.

Since the whole funnel jet electric generator is supported by the two buoys that float on the water, the whole machine to move up and down when the tide is high and low. Accordingly, the funnel jet electric generator of the present invention can be mounted to a retaining arrangement 50 which is mounted to an underwater ground such a sea ground or a river ground.

According to this preferred embodiment of the present invention, the retaining arrangement 50 comprises a first support 51 adjacent to the two funnel jets 10, a top connecting member 52 and a bottom connecting member 53 connecting the funnel jets 10 together and each has a mounting hole, and a second support 54 adjacent to the housing 31 of the electric generator 30. The first support 52 penetrates the mounting hole of each of the top connecting member 52 and the bottom connecting member 53 in such a manner that the top connecting member 52 and the bottom connecting member 53 are capable of moving up and down with the tide to guide the two funnel jets 10 to move up and down along the first support 51. Similarly, the retaining arrangement 50 further comprises one or more fasteners 55 such as two fasteners 55 mounted to the housing 31 of the electric generator 30 via screws 56 in such a manner that the two fasteners 55 move up and down along the second support 54 to guide the housing 31 of the electric generator 30 to correspondingly move up and down.

It is worth mentioning that the whole funnel jet electric generator will not roll at the two sides and the funnel jet electric generator is able move up and down smoothly due to the first support 51, the top connecting member 52, the bottom connecting member 53, the second support 54, and the two fasteners 55 of the retaining arrangement 50. In other words, the stability of the funnel jet electric generator is enhanced and the upward and downward movement enables the funnel jet electric generator to stay on the water with the nozzles 12 of the funnel jets 10 tilted out of the water surface to provide stable water jets that activate the power transmission system 20 to drive the electric generator 30 to produce electricity.

Accordingly, the funnel jet electric generator may further comprise a battery 35 for storing the electric power produced by the electric generator 30 for further utilization.

Accordingly, in this preferred embodiment of the present invention, a method of using wave power via a funnel jet electric generator is disclosed. The method comprises the following steps.

(a) Define a relatively large entrance at a first side of a funnel jet 10 for capturing a wave crest and a relatively small exit at a second side thereof.

(b) Compress the wave crest via a channel 113 of the funnel body 11 of the funnel jet 10 in such a manner that the wave crest is projected out through the relatively small exit of the funnel jet 10 to create a water jet.

(c) Transmit the kinetic energy of the water jet to drive an electric generator to produce electricity.

According to the preferred embodiment of the present invention, the wave crest enters into the funnel jet 10 through a funnel extension tube 13 with a reinforced ring 14 and is guided to the channel 113 before projecting out of the funnel body 11 through a nozzle 12 of the funnel jet 10.

Accordingly, the method further comprises a step of (d): tilt the nozzle 12 of the funnel jet 10 out of water surface in such a manner that an inclined angle is defined between a middle line of the funnel jet 10 and a water surface line, so that the water jet is projected through the nozzle 12 into the air to avoid resistance of water in a sea or river.

The step (c) further comprises a step (c.1): transmit the energy of the water jet to a power transmission mechanism 22 via at least one bucket turbine 21, and step (c.2): transform the power in the power transmission mechanism 22 from the kinetic energy of the water jet to the electric generator 30 for producing electricity.

More specifically, according to this preferred embodiment, the transmission gear mechanism 22 comprises a connecting shaft 221 linking two bucket turbines 21, a connecting shaft gear 222 which is coupled with the connecting shaft 221 of the two bucket turbines 21, a generator shaft 223 coupled with the electric generator 30, and a generator gear 224 coupled with the generator shaft 223 of the electric generator 30.

In other words, the wave energy is transformed into the kinetic energy of the water jet which is then orderly transmitted to the bucket turbines 21, the connecting shaft 211 of the bucket turbines 21, the connecting shaft gear 222, the generator gear 224, the generator shaft 223, and finally the electric generator 30.

The method further comprises a step (e) of supporting the funnel jet electric generator on the water via at least one buoy 40 floating on the water and a retaining arrangement 50 that enables the funnel jet electric generator to move up and down in response to tides of the waves.

As an example discussed above, the retaining arrangement 50 comprises a first support 51 adjacent to the two funnel jets 10, one or more connecting member 52 and 53 connecting the funnel jets 10 together, a second support 54 adjacent to the housing 31 of the electric generator 30, and one or more fasteners 55 mounted to the housing 31 of the electric generator 30. Therefore, the connecting member 52 and 53 are capable of moving up and down with the tide to guide the two funnel jets 10 to move up and down along the first support 51, and the two fasteners 55 moves up and down along the second support 54 to guide the housing 31 of the electric generator 30 to correspondingly move up and down.

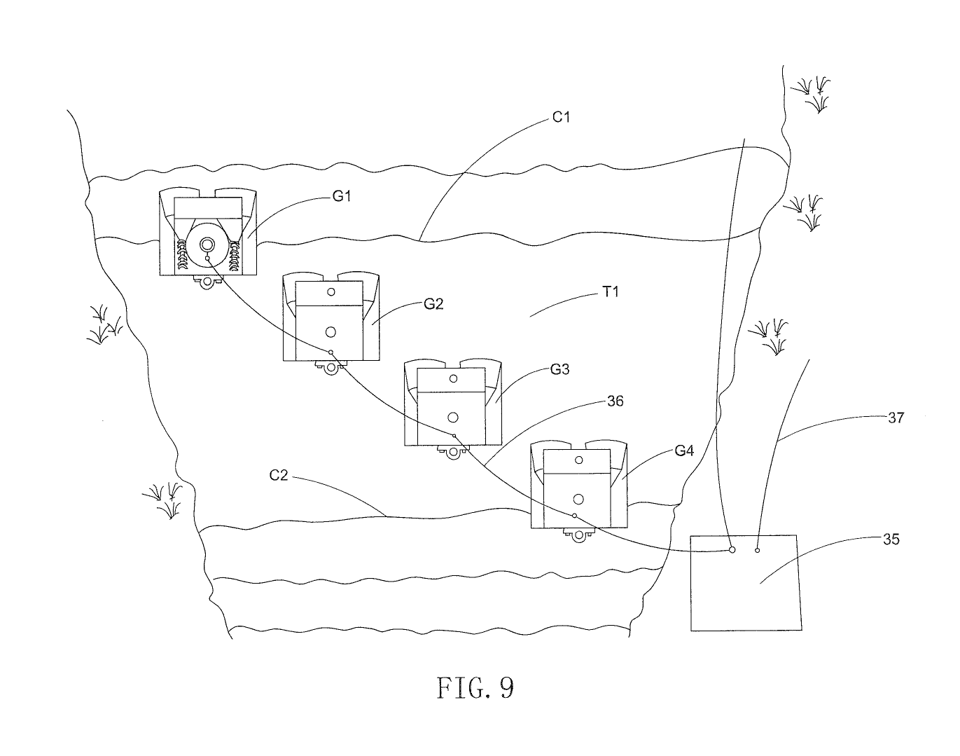

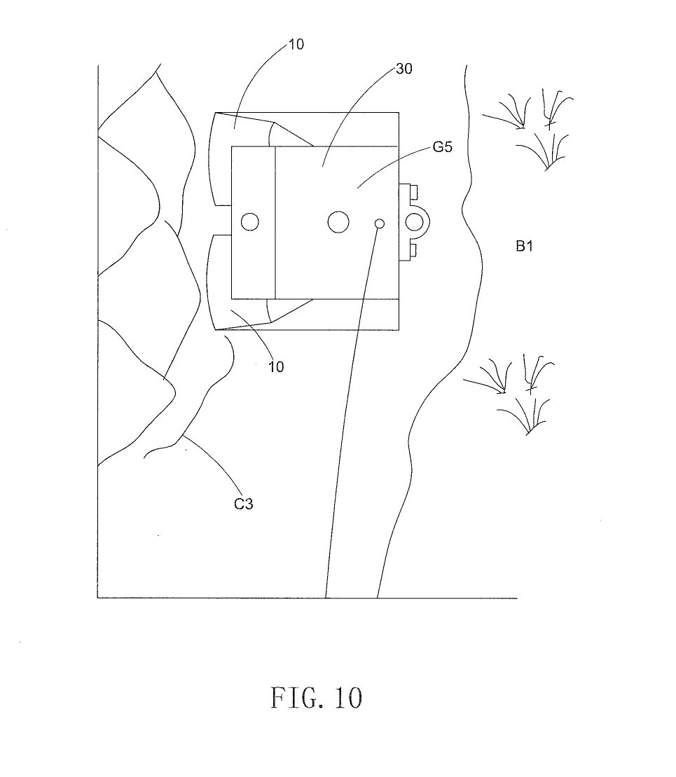

Referring to FIGS. 9 and 10 of the drawings, a preferred location for installing the funnel jet electric generator of the present invention is a gulf area or a beach area where big and long waves propagate towards the beach sand one by one, such as the Seal Beach in San Francisco USA.

FIG. 9 illustrates the wave crests C1 and C2 and wave trough T1 generated by two V-shape Funnel banks. Since the intervals, or wave trough between the wave crests are at different beaches. The number of funnel jet electric generators can be adjusted according to practical requirements of the environment. For a longer wave interval, it may be preferred to arrange more funnel jet electric generators. As shown in FIG. 9 of the drawings, the interval can accommodate four funnel jet electric generators G1, G2, G3, and G4 which are formed in one row and connected with each other via electric cables 36.

When the wave crest C1 passes the funnel jet electric generator G1, the funnel jet electric generator G1 is operates to produce electricity. The funnel jet electric generators G2 and G3 are in water trough T1 and do not produce electricity. For the funnel jet electric generator G4, the wave crest C2 has just passed. Therefore, the three funnel jet electric generator G2, G3, and G4 are now not supplied with direct wave energy for producing electricity, but the inertia of the runner of the electric generators 30 still generates electricity for a while. So when the wave crest C1 passes the funnel jet electric generator G2, G3, and G4 one by one, each of the funnel jet electric generator G2, G3, and G4 will correspondingly operate to generate electricity.

In this arrangement, electricity will be supplied continuously to the battery 35 and then supply to a user or an electricity company by cables 37. Accordingly, this arrangement of this preferred embodiment works like a four-cylinder auto engine. In addition, a beach which can generate lower wave crest can be arranged with more rows of funnel jet electric generators of the present invention.

FIG. 10 illustrates the installation of the funnel jet electric generator in big and short wave crest areas. Usually the wave crests in the ocean are short and go to any direction. It is acknowledged that when the big and short wave crests hit a rock or a wall of a cliff band, the waves will splash up to the air. Therefore, the funnel jet electric generator of the present invention can be placed randomly at any location in the sea which is enough high for short waves crests to splash up to the air for operating the funnel jet electric generator.

As shown in FIG. 10 of the drawings, a funnel jet electric generator G5 is placed at the sea near a cliff bank B1. The big and short waves crests C3 hit the two funnel jets 10 just like when waves hit the rock in the sea, so that water jets are generated to activate the bucket turbines 21 for driving the electric generator 30 to generate electricity. Although not shown in the drawings, it is worth mentioning that the funnel jet electric to generator of the present invention can also use the water flow of a river or stream to generate electricity.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A funnel jet for transforming wave power into kinetic energy of water jet that is used for driving an electric generator to generate electricity, comprising:
a funnel body defining a channel,
a funnel extension tube connected to a first end portion of said funnel body for capturing a wave crest, and
a nozzle connected to a second end portion of said funnel body, wherein the wave crest is guided into said funnel body along said channel and projects out through said nozzle to produce the water jet.

2. The funnel jet, as recited in claim 1, further comprising a reinforced ring coupled with said funnel extension tube for retaining said funnel extension tube in position.

3. The funnel jet, as recited in claim 2, wherein said funnel extension tube and said nozzle are integrated with said funnel body, wherein said funnel extension tube defines a bigger entrance for the wave crest, wherein said nozzle defines a smaller exit, so that said wave crest captured by said funnel extension is compressed and forced to project out through said nozzle to create the water jet.

4. The funnel jet, as recited in claim 3, wherein said nozzle is tilted out of a water surface to define an inclined angle between a central axis of said funnel jet with a water surface line.

5. The funnel jet, as recited in claim 3, further comprising at least one buoy floating on the water, wherein said funnel jet moves up and down in response to a tide of waves.

6. The funnel jet, as recited in claim 5, further comprising a connecting plate comprising a nozzle ring and a nozzle blocking member able to move between an open state in which said nozzle ring is positioned at said nozzle for creating the water jet and a closed state in which said nozzle blocking member is sealed at said nozzle for blocking the water jet.

7. The funnel jet, as recited in claim 6, further comprising an actuator connected to said buoy, wherein said connecting plate is installed to an end of a rod of said actuator in such a manner that said connecting plate is actuated to move transversely at said nozzle.

8. A funnel jet electric generator, comprising:
at least one funnel jet each comprising:
a funnel body defining a channel,
a funnel extension tube connected to a first end portion of said funnel body for capturing a wave crest,
a nozzle connected to a second end portion of said funnel body, wherein said wave crest is guided into said funnel body along said channel and projects out through said nozzle to produce a water jet,
a power transmission system, and
an electric generator, wherein kinetic energy of said water jet is transmitted to said electric generator for producing electricity through said power transmission system.

9. The funnel jet electric generator, as recited in claim 8, wherein said power transmission system further comprises a two or more buck turbines that are respectively propelled by said water jets created by said funnel jets for transforming the kinetic energy of said water jet to mechanical power and a transmission gear mechanism for directing said mechanical power of said buck turbines to said electric generator and a gear box for receiving said transmission gear mechanism, wherein said two bucket turbines are mounted at two sides of said gear box.

10. The funnel jet electric generator, as recited in claim 9, wherein said transmission gear mechanism comprises a connecting shaft linking said bucket turbines, a connecting shaft gear which is coupled with said connecting shaft of said bucket turbines, a generator shaft coupled with said electric generator, and a generator gear coupled with said generator shaft of said electric generator, wherein the kinetic energy of said water jet is directed to said electric generator through said connecting shaft, said connecting shaft gear, said generator gear, and said generator shaft of said transmission gear mechanism.

11. The funnel jet electric generator, as recited in claim 8, wherein each of said funnel jets further comprises a reinforced ring coupled with said funnel extension tube for retaining said funnel extension tube in position.

12. The funnel jet electric generator, as recited in claim 10, wherein said nozzle and said funnel extension are integrated with said funnel body, wherein said funnel extension tube defines a large entrance for the wave crest, wherein said nozzle defines a smaller exit, so that said wave crest captured by said funnel extension is compressed and forced to project out through said nozzle to create the water jet.

13. The funnel jet electric generator, as recited in claim 12, wherein said nozzle is tilted out of a water surface to define an inclined angle between a central axis of said funnel jet with a water surface line.

14. The funnel jet electric generator, as recited in claim 12, further comprising at least one buoy floating on the water, wherein a water ballast is provided in said buoy for adjusting a floating depth of said funnel jet electric generator.

15. The funnel jet electric generator, as recited in claim 14, wherein each of said funnel jets further comprises a connecting plate comprising a nozzle ring and a nozzle blocking member able to move between an open state in which said nozzle ring is positioned at said nozzle for creating the water jet and a closed state in which said nozzle blocking member is sealed at said nozzle for blocking the water jet.

16. The funnel jet electric generator, as recited in claim 15, wherein each of said funnel jets further comprises an actuator connected to said buoy, wherein said connecting plate is installed to an end of a rod of said actuator in such a manner that said connecting plate is actuated to move transversely at said nozzle.

17. The funnel jet electric generator, as recited in claim 16, further comprising a retaining arrangement mounted to a water ground, wherein said retaining arrangement comprises at least one first support adjacent to said funnel jets, at least one connecting member connecting said funnel jets together and each has a mounting hole, wherein said first support penetrates said mounting hole of each of said connecting members in such a manner that each of said connecting members is capable of moving up and down with said tide to guide said funnel jets to move up and down along said first support.

18. The funnel jet electric generator, as recited in claim 17, wherein said electric generator further comprises a housing and a battery, wherein said retaining arrangement further comprises a second support adjacent to said housing of said electric generator, at least one fastener mounted to said housing of said electric generator in such a manner that each of said fasteners moves up and down along said second support to guide said housing of said electric generator to correspondingly move up and down.

19. The funnel jet electric generator, as recited in claim 17, wherein a plurality of said funnel jet electric generators are electrically connected to each other by a plurality of electrical cables and arranged in at least one row for generating electricity, wherein a number of said funnel jet electric generators is predetermined by a width of an interval to two wave crests.

20. The funnel jet electric generator, as recited in claim 8, wherein said funnel jet electric generator is randomly placed at sea, adjacent to a cliff bank, or in a river and stream to catch short wave crests for generating electricity.
